(19) United States
(12) Patent Application Publication
(10) Pub. No.: US 2006/0031505 A1
(43) Pub. Date: Feb. 9, 2006

(54) Accessing on-line services

(75) Inventor: Alexis S. R. Ashley, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/534,482

(22) PCT Filed: Nov. 5, 2003
(86) PCT No.: PCT/IB03/04981

§ 371 Date: May 10, 2005

(30) Foreign Application Priority Data
Nov. 15, 2002 (GB) 0226651.8

(51) Int. Cl. G06F 15/173

(52) U.S. Cl. 709/226

(57) ABSTRACT

Method is provided for controlling access by a client computer to an on-line user group hosted by a second computer, wherein the first computer stores personal data of a user. A privacy policy (16) identifying the personal data required to be provided to permit access to the user group is transmitted (18) from the host to the client as a part of the access routine. At the host a determination is made (22) as to whether a received privacy policy is acceptable and, if so, the client selects (30) from store the personal data identified in the privacy policy and transmits (28) the same to the host A programmable device configured as a client is also disclosed.

The present invention relates to the provision and regulation of access to on-line services. In particular, the invention relates to mechanisms for control of access by individuals to shared services and facilities, such as on-line user groups.

Internet protocols such as JXTA (originally developed by Sun Microsystems, Inc and described at http://www.jxta.org) allow users to form on-line groups by permitting any connected device on the network, ranging from cellular telephones and wireless PDA's to personal computers and servers to communicate and collaborate in a predetermined manner. These on-line communities are frequently based around themes, such as a common interest. For most of these groups there are no restrictions on joining the group. This is based on the idea that only people interested in the common interest will want to join.

Some groups can give users access to material they would not be able to get if not a member of the group. This type of group is less likely to have an “open door” joining policy. If there is a more restricted membership policy for a group, some sort of negotiation will have to take place to join the group. As part of this negotiation, some personal information about the user (such as name, contact details) will typically have to be provided. For some users, however, the supply of such personal information raises privacy issues, and some potential group members may be dissuaded from joining through concerns about what use will be made of their personal data.

It is an object of the present invention to at least partially address the above mentioned issue.

In accordance with a first aspect of the present invention there is provided a method for controlling access by a first computer to an on-line user group hosted by a second computer, wherein the first computer stores personal data of a user, comprising:

providing from said second computer to said first computer a privacy policy identifying the personal data required to be provided to permit access to said user group;

at said first computer determining whether a received privacy policy is acceptable; and

if acceptable, at the first computer selecting from store the personal data identified in the privacy policy and transmitting the same to the second computer.

By delivering a privacy policy specifying the use the data is to be put to, the user is better able (and more likely) to opt for acceptance. At the same time, the policy provides a specification to the users computer as to which personal data (which may be only a small subset of the personal data held by the computer) is to be transmitted.

Note: the term “computer” as used herein is intended to refer to any programmable or programmed device operable to carry out the functions recited. Such a device may typically comprise a personal or laptop computer, but may also comprise a suitably configured and capable cellular telephone, PDA, mainframe device and the like.

The first computer may present a received privacy policy to a user, with acceptance or otherwise of said policy being determined by user input: in such a case, the first computer may format the received privacy policy prior to presentation to the user, for example to present simple lists of the information required or the intended use(s) to make it more readily understandable by the user. Alternatively, the first computer may store privacy policy preference data for a user and, based on the same, determine automatically whether a received privacy policy is acceptable. With such a pre-stored preference profile, the user is not required to interact each time an access authentication request (in the form of a privacy policy) is received.

As the user may not be satisfied with the basic information carried by the privacy policy, the step of determining acceptance may include a process of negotiation between the first computer user and the host of the on-line user group, for example to enable the user to find out more about the intended use and/or destination of the data.

A received privacy policy may be partly accepted,.with only a part of the requested personal data being transmitted as a result. Such an arrangement may have use where there are different levels of entry to the on-line group, with those prepared to divulge greater personal information being granted access to successively more open levels within the user group.

Also in accordance with the present invention there is provided a computer apparatus configured for accessing an on-line user group hosted by a second computer and comprising:

storage means for personal data of a user of the apparatus;

communications means operable to exchange data with the second computer over a data link and receive from said second computer a privacy policy identifying the personal data required to be provided to permit access to said user group;

programmable processor means configured to determine whether a received privacy policy is acceptable and, if so, to select from said storage means the personal data identified in the privacy policy and, via the communications means, transmit the same to the second computer.

The invention further relates to a software utility operable to configure a programmable device to perform the functions of the first computer in the method recited above, as well as to a storage device holding such a software utility.

These and other aspects of the present invention are recited in the appended claims which are incorporated herein by reference and to which the reader is now referred, and/or are described in the following description of embodiments of the invention.

Embodiments of the present invention will now be described by way of example only with reference to the accompanying drawings in which:

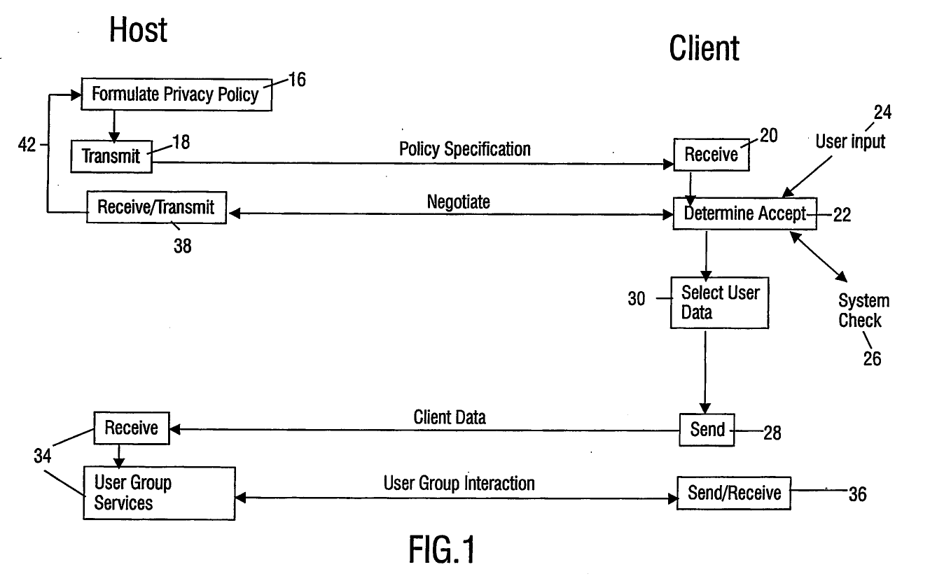

FIG. 1 schematically represents a series of interactions between the host of a user group and the client device of a user wishing to join the group;

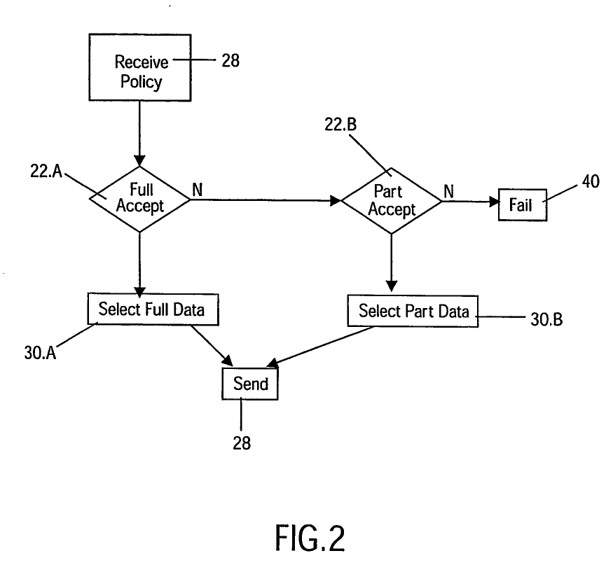

FIG. 2 is a flow chart illustrating alternative steps that may be carried out at the client side in FIG. 1; and

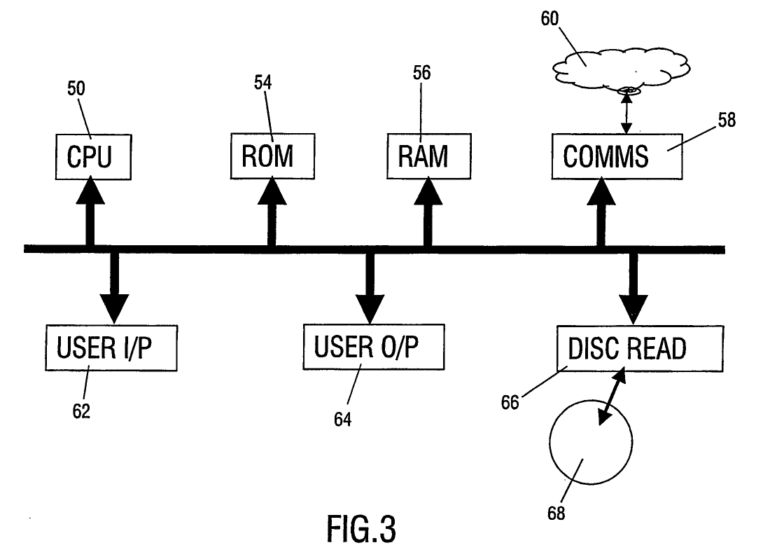

FIG. 3 schematically represents functional features of a client apparatus suitable to embody the present invention.

Referring initially to FIG. 1, a series of interactions between a first (client) computer (to the right of the Figure) of a user wishing to join an on-line user group, and a second (host) computer (to the right) hosting the user group are illustrated.

Before anyone can be invited to join a restricted group, the creator of the group will have to create 16 a privacy policy file. The privacy policy file describes all the items of information that are required to join the group, and the intended use for this information. In the following example, the W3C standard P3P (Platform for Privacy Preferences) is used, as described at http://www.w3.org/TR/P3P, but other representations would be equally applicable.

<POLICIES xmlns=“http://www.w3.org/2002/01/P3Pv1”>
<POLICY name=“sample”

discuri=“http://www.example.com/join-policy.html”
opturi=“http://www.example.com/opt.html”>
<ENTITY>

<DATA-GROUP>

<DATA ref=“#business.name”>Example, Corp.</DATA>
<DATA ref=“#business.contact-

info.online.email“>privacy@example.com</DATA>

</DATA-GROUP>

</ENTITY>
<ACCESS><none/></ACCESS>
<DISPUTES-GROUP>

<DISPUTES resolution-type=“service”
service=“http://www.example.com/privacy.html”
short-description=“Please contact our customer service desk

with privacy concerns by emailing
privacy@example.com”/>

</DISPUTES-GROUP>
<STATEMENT>

<PURPOSE><admin/><contact /></PURPOSE>
<RECIPIENT><ours/></RECIPIENT>
<RETENTION><indefinitely/></RETENTION>
<DATA-GROUP>

<DATA ref=“#user.name”/>
<DATA ref=“#user.cert
<DATA ref=“#user.home-info.online”/

</DATA-GROUP>

</STATEMENT>

</POLICY>

</POLICIES>

Once this policy file has been created, anyone wishing to join the group can retrieve the file in order to discover the personal information requirements for membership.

Whilst a detailed discussion of the above example is not necessary, some of the parts will now be identified for the purposes of illustration.

DATA ref=These references identify the data sought, such as user name and contact details.

DISPUTES resolution-type=Specifies a mechanism for negotiating or otherwise seeking data about the privacy policy/personal data submission request. In the above example, this is in the form of an e-mail address for a customer service desk.

RECIPIENT

Who will receive the data.

RETENTION

How long the data will be held by the recipient (indefinitely in the above example).

Once this policy file has been created, it needs to be transferred 18 to the client device. The exact details of this transfer are outside of the scope of this invention, but the skilled reader will be aware of suitable mechanisms for transferring data (in conjunction with other on-line group data or separately) to the client device.

Once received 20 by the client device, the next step 22 is determining whether or not the stated requested data and its intended uses are acceptable to the user. In an interactive mode, the privacy policy could be displayed to the user (suitable reformatted in some easier to understand form that raw XML), with user input 24 indicating acceptance or otherwise. Alternatively, in a system check 26 a software agent or routine on the device can make a decision on the policy file based on previous configuration (stored privacy policy preference data) by the user. The determination may include a negotiation or explanation step with the user contacting the host 38, for example to seek further information about the intended use and/or destination of the user data. As indicated by arrow 42, this process may conceivably result in the host reviewing or amending the privacy policy.

When the users personal data is transferred 28 from the client to the host, the policy file is used to filter it 30. For example if the policy file indicated that only a name and contact details were required, all other information (such as the users age and gender) would be removed before (or simply not selected for) transfer.

In operation, when a potential client seeks to subscribe to the host service, the host transmits their privacy policy file to the client. Ancillary information may be carried along with the privacy file to indicate if acceptance of this policy was a pre-requisite of using their service and, if so, whether different levels of access may be available (as discussed below). As indicated generally at 34 and 36, on receipt of users personal data, the host makes available access to the user group.

FIG. 2 illustrates a variation in the process followed by the client device in FIG. 1. Following receipt of the privacy policy at 28, a first acceptance test 22.A (which may be interactive or automated as described above) is performed. This test looks for acceptance of all the specifications (data types, intended use, retention time and so forth) identified in the privacy policy. If the test is met, then all the required data is selected 30.A from that held by the receiver and sent 28 to the host. If the test 22.A fails however, a second test 22.B is made for partial acceptance, for example to determine if the user is willing to submit some of the requested data (which may still permit limited access to the user group). If the second test 22.B fails, the process stops 40, no data is sent to the host, and the attempt to access the user group fails. If the second test is successful, however, the selection 30.B from the stored data comprises just that personal data that the user is prepared to submit, which data is then sent 28 as before.

FIG. 3 schematically illustrates the functional elements of a programmable or programmed apparatus fulfilling the role of the client device. The apparatus comprises a central processing unit (CPU) 50 coupled via an address and data bus 52 to read-only 54 and random-access 56 memories. A communications stage 58 (for example a modem or link to a broadband service) supports communications via the internet 60 or another communications network to the computer (not shown) hosting the on-line user group.

User input means 62 may comprise a keyboard, mouse, tracker ball or data tablet, and user output means 64 may comprise a monitor or integral display screen, status display unit and/or audio output means. Lastly, a reader 66 for removable storage devices 68 (such as optical or floppy discs) provides access to further information storage and/or retrieval. As will be recognised, a removable storage device 68 may carry a software utility downloadable to the CPU 50 which utility configures the apparatus to carry out the functions of a client computer as described above.

Devices 58, 62, 64 and 66 are also connected to the CPU 50 via the bus 52.

Operationally, the apparatus provides a client device configured for accessing an on-line user group hosted by a second computer and comprising storage means (typically in RAM 56) for personal data of a user of the apparatus. The communications stage 58 is operable to exchange data with a host over the internet (or other data link) and receive from the host the privacy policy identifying the personal data required to be provided to permit access to the desired user group.

The CPU 50 provides means configured to determine whether a received privacy policy is acceptable and, if so, to select from RAM 56 the personal data identified in the privacy policy and, via the communications stage 58, transmit the same to the host computer.

The display 64 or other output device provides a means whereby the CPU 50 may present a received privacy policy to a user (suitably following formatting for easier readability), and the keyboard 62 or other user input provides a means by operation of which a user determines acceptance or otherwise of said policy. Rather than such an interactive approval process, the storage means (ROM 54, RAM 56 or disc 68) may hold privacy policy preference data for a user and, based on the same, the CPU 50 is suitably enabled to determine automatically whether a received privacy policy is acceptable. As described above with reference to FIG. 2, the CPU 50 may 10 be further operable to determine partial acceptance of a received privacy policy, and to select from storage only a part of the requested personal data.

In the foregoing we have described a method for controlling access by a client computer to an on-line user group hosted by a second computer, wherein the first computer stores personal data of a user. A privacy policy identifying the personal data required to be provided to permit access to the user group is transmitted from the host to the client as a part of the access routine. At the host a determination is made as to whether a received privacy policy is acceptable and, if so, the client selects from store the personal data identified in the privacy policy and transmits the same to the host. A programmable device configured as a client is also disclosed.

From reading the present disclosure, other modifications will be apparent to persons skilled in the art. Such modifications may involve other features which are already know in the field of on-line services, methods and apparatuses supporting the same, and applications thereof, and which may be used instead of or in addition to features already described herein.

1. A method for controlling access by a first computer to an on-line user group hosted by a second computer, wherein the first computer stores personal data of a user, comprising:
providing (18) from said second computer to said first computer a privacy policy identifying the personal data required to be provided to permit access to said user group;
at said first computer determining (22) whether a received privacy policy is acceptable; and
if acceptable, at the first computer selecting (30) from store the personal data identified in the privacy policy and transmitting (28) the same to the second computer.

2. A method as claimed in claim 1, wherein the first computer presents a received privacy policy to a user, and acceptance or otherwise of said policy is determined by user input (24).

3. A method as claimed in claim 2, wherein the first computer formats the received privacy policy prior to presentation to the user.

4. A method as claimed in claim 1, wherein the first computer stores privacy policy preference data for a user and, based (26) on the same, determines (30) automatically whether a received privacy policy is acceptable.

5. A method as claimed in claim 1, wherein the step (22) of determining acceptance includes a process of negotiation (38) between the first computer user and the user group host.

6. A method as claimed in claim 1, wherein a received privacy policy may be partly accepted (22.B), with only a part (30.B) of the requested personal data being transmitted (28) as a result, and only limited access being granted to the on-line user group.

7. Computer apparatus configured for accessing an on-line user group hosted by a second computer and comprising:
storage means (54, 56, 68) for personal data of a user of the apparatus;
communications means (58) operable to exchange data with the second computer over a data link (60) and receive from said second computer a privacy policy identifying the personal data required to be provided to permit access to said user group;
programmable processor means (50) configured to determine whether a received privacy policy is acceptable and, if so, to select from said storage means (54, 56, 68) the personal data identified in the privacy policy and, via the communications means (58), transmit the same to the second computer.

8. Apparatus as claimed in claim 7, further comprising an output device (64) wherein the processor means (50) presents a received privacy policy to a user, and user input means (62) by operation of which a user determines acceptance or otherwise of said policy.

9. A method as claimed in claim 8, wherein the processor means (50) is arranged to format the received privacy policy prior to presentation by the output device (64).

10. Apparatus as claimed in claim 7, wherein the storage means (54, 56, 68) holds privacy policy preference data for a user and, based on the same, the processor means (50) determines automatically whether a received privacy policy is acceptable.

11. Apparatus as claimed in claim 7, wherein the processor means (50) is further operable to determine partial acceptance of a received privacy policy, and to select from said storage means (54, 56, 68) only a part of the requested usage data.

12. A software utility operable to configure a programmable device to perform the functions of the first computer in a method as claimed in claim 1.

13. A storage device (68) holding a software utility as claimed in claim 12.
